(19) United States
(12) Patent Application Publication
(10) Pub. No.: US 2009/0048414 A1
(43) Pub. Date: Feb. 19, 2009

(54) MAGNETIC COUPLING THROUGH STRONG HYDROGEN BONDS

(75) Inventors: John A. Schlueter, Warrenville, IL (US); Jamie L. Manson, Spokane Valley, WA (US)

Correspondence Address: FOLEY & LARDNER LLP, 321 NORTH CLARK STREET, SUITE 2800, CHICAGO, IL, 60610-4764, US

(73) Assignee: UChicago Argonne, LLC

(21) Appl. No.: 11/839,990

(22) Filed: Aug. 16, 2007

(51) Int. Cl. C08G 73/06

(52) U.S. Cl. 528/9

(57) ABSTRACT

A composition of matter for a polymeric material for magnetic coupling through strong hydrogen bonds. A hydrogen bound structural directing entity, such as the bifluoride ion, HF₂⁻, or coordination polymers incorporating strong OH...F type interactions can be used to manufacture organic polymers which allow, via strong hydrogen bonds, the bridging across polymeric magnetic layers to couple spin-polarized electrons to the conduction band, in order to enable control of the electron spin state for spintronic applications.

The United States Government certain rights in this invention pursuant to Contract No. W-3′-109-ENG-38 between the United States Government and The University of Chicago and/or pursuant to Contract No. DE-AC02-06CH11357 between the United States Government and UChicago Argonne, LLC representing Argonne National Laboratory.

This invention is directed toward a family of magnetic polymers and methods for producing them. More particularly, the invention is directed toward new types of polymers having magnetic properties that are accompanied by strong hydrogen bonds which can be manipulated to control electron spin state, or magnetic state, for various commercial applications, such as computer switching applications.

### BACKGROUND OF THE INVENTION

Substantial efforts are being diverted to the emerging field of “spintronics,” also known as spin electronics or magnetoelectronics and quantum computing. This technology is concerned with developing compositions and products which exploit the physics of electron spin state, as well as the electron charge. While conventional electronics use the charge of the electron, spintronic devices would use both the spin and charge, achieving superior performance. Such devices, utilizing both the spin and charge of the electron, offer the possibility of dramatically higher performance and lower energy dissipation than today's charge-based semi-conductor technology. To achieve this, there is a need to couple conduction and magnetic electrons in molecular systems. Heretofore, spintronic technologies have been based on epitaxially grown inorganic and ceramic multilayers. Attempts to construct organic spintronic devices are also based on sputtered multilayers which are full of defects. Inorganic spintronic materials are not ideal because they exhibit significant spin-orbit coupling. Any epitaxial approach will also suffer from irregular interfaces and defects. Attempts to observe long-range magnetic order coupled through hydrogen bonding have failed mainly because the previous systems utilized weak hydrogen bonds and were not well designed.

### SUMMARY OF THE INVENTION

Commercially useful spintronic components can be manufactured by controlled growth. The methodology herein is the controlled growth of strongly hydrogen bound, magnetic coordination polymers through a mild ‘building-block’ approach. Coordination polymers have therefore been synthesized using hydrogen bonds to mediate magnetic coupling. Such hydrogen bonds derive from a hydrogen interaction with a highly electronegative element, and in a most preferred embodiment, the building blocks of bifluoride ions HF₂⁻ form robust hydrogen bonds that bridge magnetic layers composed of magnetic copper ions held in a planar square array by bidentate molecules such as pyrazine. A second preferred embodiment consists of coupling unpaired electron spins through use of strong OH—F interactions. Ordering of the spins in the three dimensional (3D) framework at low temperature has demonstrated that hydrogen bonds function not only as structural elements, but also can act as mediators of magnetic superexchange. The synthesis of these polymers opens a route to new solid-state coordination compounds where hydrogen bonds control the spin arrangement of the neighboring magnetic centers. These hydrogen bound magnetic polymers can also operate as magnetic switches whereby the symmetric/asymmetric placement of the bifluoride hydrogen atom could be controlled by external stimuli, thus controlling the magnetic state of the polymer.

These and other objects, advantages and features of the invention, together with the organization and manner of operation thereof, will become apparent from the following detailed description when taken in conjunction with the accompanying drawings.

### BRIEF DESCRIPTION OF THE DRAWINGS

FIG. 1A illustrates the crystal structure of [Cu(HF₂)(pyz)₂]BF₄ with pyrazine H-atoms and BF₄⁻ anions omitted for clarity and thermal ellipsoids drawn at 35% probability; FIG. 1B illustrates a chain packing arrangement for CuF₂(H₂O)₂(pyz) with a projection down the chain axis and with the dashed lines indicating F...H—O chemical bonds; and FIG. 1C illustrates linear chain groups of FIG. 1B;

FIG. 2A illustrates the magnetic susceptibility and FIG. 2B the product of magnetic susceptibility and temperature as a function of temperature for [Cu(HF₂)(pyz)₂]BF₄;

FIG. 3A illustrates specific heat for [Cu(HF₂)(pyz)₂]BF₄ obtained at H═O plotted as C/T versus T and FIG. 3B plotting d(C/T)dT versus T;

FIG. 4A illustrates the temperature dependence of the two main muon precession frequencies found in [Cu(HF₂)(pyz)₂]BF₄; and FIG. 4B shows the oscillations of the asymmetry function at 0.35K due to the presence of long range magnetic ordering;

FIG. 5A illustrates a bifluoride (HF₂⁻) anion as contemplated by valence bond theory and FIG. 5B illustrates the bifluoride anion contemplated by molecular orbital theory; and

FIG. 6A illustrates a magnetic layer of a plurality of conducting/magnetic layers of the spintronic device layer structure shown in FIG. 6B.

### DETAILED DESCRIPTION OF PREFERRED EMBODIMENTS

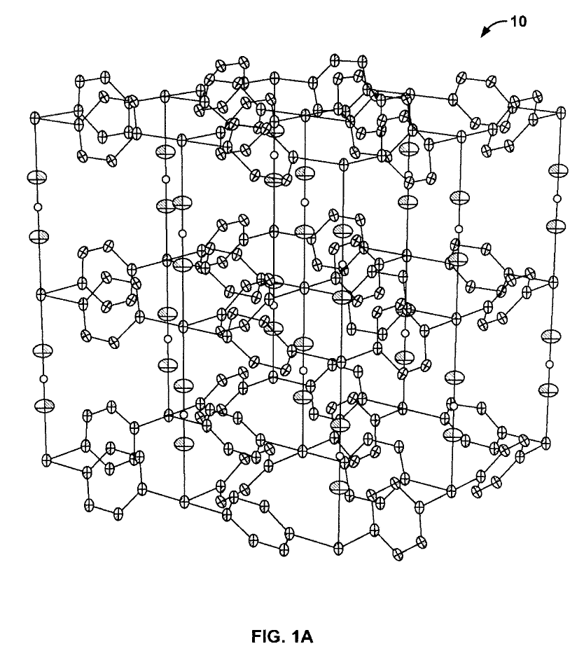

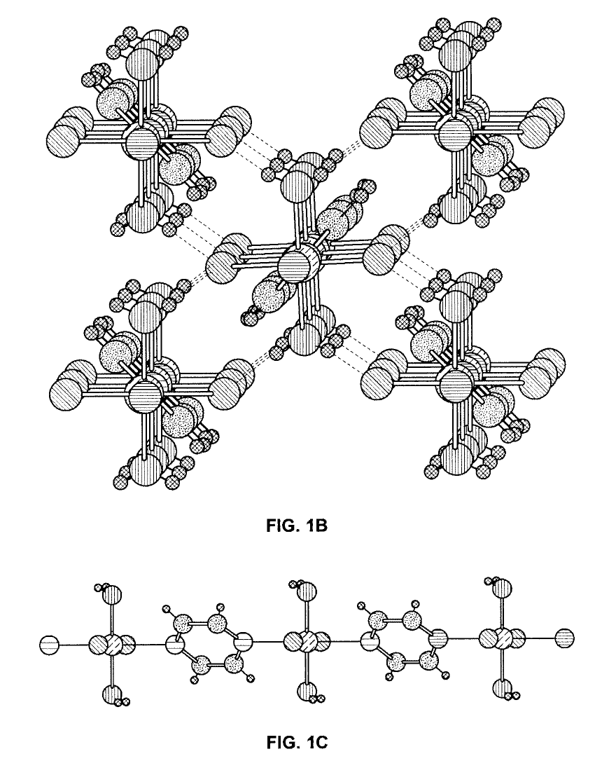

Several examples of a polymer material which enables magnetic coupling through strong hydrogen bonds are shown at 10 in FIGS. 1A, 1B and 1C. The [Cu(HF₂)(pyz)₂]BF₄ polymer material 10 consists of rare μ_{1,3} bridging HF₂⁻ anions and μ-pyrazine ligands leading to a 3D pseudo-cubic framework that antiferromagnetically orders below about 1.54 K.

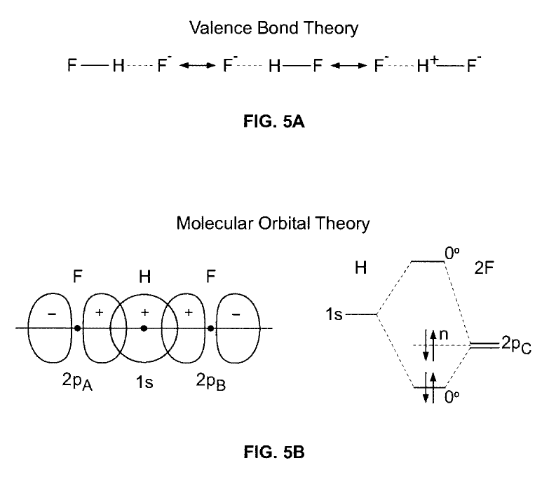

The bifluoride ion, i.e., HF₂⁻, contains a two-coordinate H-atom exhibiting the strongest known hydrogen bond. Molecular orbital theory and various structural investigations suggest that this molecule can be best described as a hydrogen cation that is bridging two fluoride anions as in F⁻...H⁺...F. Resonance modes consisting of coordinate covalent interactions such as F—H...F⁻ and F⁻...F—H may also be important (see FIGS. 5A and 5B) for representations of HF₂⁻ as contemplated by valence bond theory and molecular bond theory, respectively. In the KHF₂ and the NH₄HF₂ salts, the H...F bond lengths in the HF₂⁻ anion are equivalent at 1.14 Å, which is substantially shorter than the H...F hydrogen bond distance of 1.57 Å found in the solid phase of HF. Similarly, strong O—H...F⁻ interactions can act as important structure directing entities as well as mediators of magnetic superexchange. Compositions which include these entities are likewise included within the scope of this invention. These two embodiments are represented generally hereinafter in FIGS. 1A, 1B and 1C which show a layering structure for such polymer materials.

Pyrazine (“pyz” hereinafter) has been extensively utilized as a neutral bridging ligand in the self-assembly of polymeric networks comprised of transition metal cations. Furthermore, pyz is well known to facilitate long-range antiferromagnetic ordering with a range of exchange coupling constants. Two important examples, Cu(NO₃)₂(pyz) and Cu(ClO₄)₂(pyz)₂, which form one-dimensional (1D) chains and two-dimensional (2D) square lattices, respectively, have been identified as low-dimensional S=½ antiferromagnets. In a more recent example, bulk magnetic ordering has been reported in 2D layered Fe(NCS)₂(pyz)₂ which exhibits Ising-like magnetic behavior.

HF₂⁻ can be used affirmatively as a rational building block under mild conditions while previously reported compounds fortuitously generate this anion in situ under harsh conditions when aqueous HF is used as a solvent. While pipzH₂[MnF₄(HF₂)] (pipz=piperazine) contains a bridging bifluoride anion, no magnetic interaction was observed. HF₂⁻ can in fact, when properly assembled in a polymer, such as the polymer material 10, be a suitable superexchange ligand. To this end, the coordination polymer, [Cu(HF₂)(pyz)₂]BF₄ has been manufactured by aqueous reaction of stoichiometric amounts of copper(II) tetrafluoroborate hydrate, ammonium bifluoride, and pyz.

The crystal structure of [Cu(HF₂)(pyz)₂]BF₄ has been determined using conventional X-ray diffraction methods. Each Cu²⁺ center occupies a 422 symmetry site and lies at the center of a slightly elongated octahedron with four Cu—N and two Cu—F(2) bond distances of 2.040(4) and 2.207(4) Å, respectively. Owing to the high symmetry of the Cu site, all F(2)-Cu—N, N—Cu—N, and F(2)-Cu—F(2′) bond angles are regular, i.e., 90 and 180°. The HF₂ anion features a symmetrically placed hydrogen atom located at a 422 site with H—F and F...F bond distances of 1.102 and 2.205 Å, respectively.

The extended structure of [Cu(HF₂)(pyz)₂]BF₄ is polymeric with the three-dimensional (3D) framework shown in FIG. 1A. Infinite 2D [Cu(pyz)₂]²⁺ sheets are formed in the ab-plane that are connected along the c-axis by linearly bridging μ_{1,3}-HF₂⁻ anions. By comparison, Cu(ClO₄)₂(pyz)₂ has a similar 2D network, however, the ClO₄⁻ anions do not bridge between the 2D [Cu(pyz)₂]²⁺ sheets but rather are terminal groups. The ClO₄⁻ anions pack in between the layers in such a way as to cause the sheets to be mutually staggered. From FIG. 1A, it can be seen that the pyz ligands in [Cu(HF₂)(pyz)₂]BF₄ are all tilted out of the ab-plane by 59.4° in a pattern consistent with the 4-fold rotation symmetries of the copper sites. A similar rotation of pyz rings along M-pyz-M bridges has been reported in quasi-2D [Cu(NO₃)(pyz)₂]PF₆. Because the Cu...Cu separations along the Cu-pyz-Cu and Cu—FHF—Cu linkages are very similar [6.8519 and 6.6193 Å, respectively], the structure may be described as pseudo-cubic. The BF₄ anions occupy the body-centered positions within each “cubic” pore, with the B-atom resting on a 4̅ 2m site.

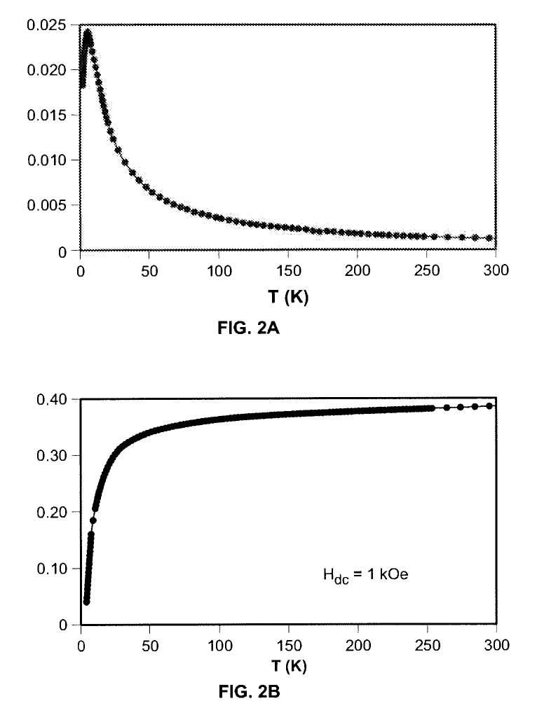

The magnetic properties of [Cu(HF₂)(pyz)₂]BF₄ were probed using a SQUID magnetometer and data collected upon warming between 2 and 300 K. FIG. 2A shows χ vs. T while χT vs. T is plotted in FIG. 2B. At room temperature, the value of χT is 0.367 emuK/mol, which is slightly smaller than the expected value of 0.375 emuK/mol for isolated spin-½ Cu²⁺ cations. Upon cooling, χT decreases continuously until ˜50 K, below which it falls off much more rapidly owing to increasing antiferromagnetic correlations between Cu²⁺ sites. Susceptibility, χ, reaches a broad maximum at 5.5 K, which is likely due to short-range magnetic interactions. Below χₘₐₓ, the data decrease continuously to the lowest measured temperature of 2 K, reaching a value of 0.017 emu/mol. The observed broad maximum, albeit at a lower temperature, is very similar to that found for 2D Cu(ClO₄)₂(pyz)₂. A Curie-Weiss fit of χ between 6 and 300 K yielded g=2.048 and θ=−8.1 K which indicates antiferromagnetic coupling between the spin-½ Cu²⁺ ions in the title compound. Within the limited temperature range of the SQUID magnetometer, there was no evidence for long-range magnetic ordering (LRO) above 2 K.

The magnetic Cu 3d_{x2-y2} orbital of each CuN₄F₂ octahedron lies in the CuN₄ plane so that the spin exchange interactions between neighboring Cu²⁺ ions occur through the σ-bonded pyz ligands (see also FIG. 5B). Therefore to a first approximation, the magnetic structure of [Cu(HF₂)(pyz)₂]BF₄ can be described by a 2D square lattice. A least-squares fit of χ to a spin-½ Heisenberg square lattice antiferromagnet (H=−JΣSᵢ·Sⱼ) yields a good agreement for g=2.078(1) and Jlk_{B}=−2.85(1) K between 6 and 300 K (solid line in FIG. 2A). The J-value obtained from the fit is consistent with the mean-field result, |k_{B}T(χₘₐₓ)|JS(S+1)=2.53, which gave |Jlk_{B}|=2.90.

This suggests the interactions between adjacent 2D square nets, which occur via the HF₂⁻ bridges, to be very weak, because each HF₂⁻ bridge that connects two Cu²⁺ ions lies on the 4-fold rotational axis of the Cu 3d_{x2-y2} magnetic orbital so that the F 2p_{z} orbitals cannot overlap with this metal orbital. Nevertheless, spin polarization arguments hint that the Cu—F—H—F—Cu pathway may lead to a weak ferromagnetic interaction, i.e. Cu(↑)-F(↓)-H(↑)-F(↓)-Cu(↑), although lower temperature magnetic susceptibility data are needed to confirm this. It should be noted that axial-axial Cu²⁺ connections could in turn promote a weak antiferromagnetic interaction as found in Cu(dca)₂(pym).CH₃CN for example. While the sign of the exchange interaction along the HF₂⁻ bridge is presently unclear, LRO is expected to occur in [Cu(HF₂)(pyz)₂]BF₄, albeit at low temperature.

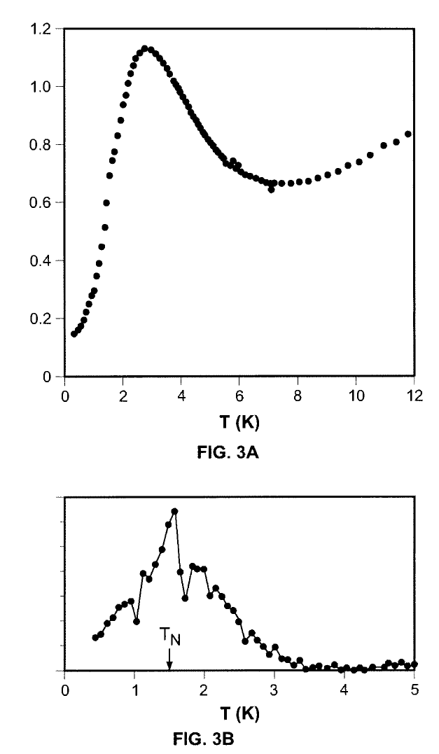

In order to search for LRO in [Cu(HF₂)(pyz)₂]BF₄, zero-field specific heat and muon-spin relaxation (ZF-μ⁺SR) studies have been carried out. Specific heat data (see FIG. 3A) shows a broad peak in C/T near ˜2.5 K which is likely due to substantial short-range magnetic ordering. Noticeably absent is a λ-anomaly that would signify the onset of long range ordering. However, close inspection of the data reveals a subtle change in slope around 1.5 K and by plotting d(C/T)/dT as a function of temperature (see FIG. 3B), a clear peak is resolved at 1.55 K, thereby indicating long range ordering. Theoretically, it has been found that the magnitude of the λ-anomaly depends on the strength of the 3D magnetic interaction. As the ratio J′/J approaches 0.01, the λ-anomaly vanishes. This places an upper limit of ˜0.03 K on the value of J′, however the susceptibility data suggest that J′ may be even smaller.

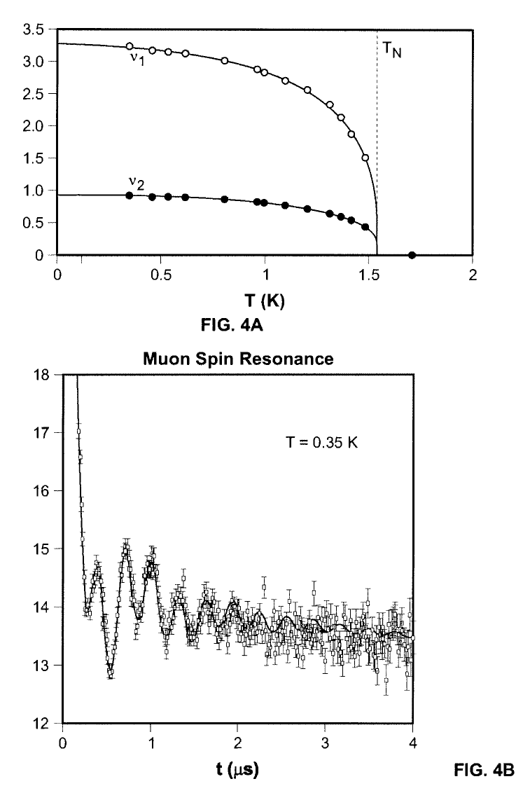

Implanted muons act as microscopic magnetometers that can detect small internal magnetic fields in a material, and this has been done for measurements herein. In a magnetically ordered compound below T_{N}, the muon spins may precess coherently at a frequency, ν, that is proportional to the order parameter of the system. Following this behavior as a function of temperature allows us to probe the magnetic phase transition as shown in FIG. 4A. Muon spin resonance is shown in FIG. 4B as evidence of long range order percentage as a function of time. For [Cu(HF₂)(pyz)₂]BF₄, two distinct procession frequencies owing to the presence of two muon stopping sites were found. The lines in FIG. 4A are fits of the data to the power law, ν(T)=ν(0)[1−(T/T_{N})^{χ}], where ν₁(0)=3.26(1) MHz, ν₂(0)=0.94(1) MHz, T_{N}=1.54(1) K, χ=2.2(1), and β=0.29(2). The β-exponent obtained from the fit is similar to the value of 0.326 associated with 3D Ising behavior. Subsequently, the expression, νᵢ=γ_{μ}Bᵢ/2π(γ_{μ}=2π×135.5 MHz/T), can be used to calculate the corresponding internal fields, B₁ and B₂, which are 24.1(1) and 7.0(1) mT, respectively. While not limiting the scope of the invention, the precise type of magnetic ordering that occurs is not identified although a collinear antiferromagnetic ordering is likely to occur due to the weak single-ion anisotropy of Cu²⁺ and the primary Cu-pyz-Cu exchange pathway that is antiferromagnetic.

To determine whether the HF₂⁻ anion may contribute to the observed LRO, the ratio of T_{N}/J can be used as a rough guide. For [Cu(HF₂)(pyz)₂]BF₄, we obtain T_{N}/J=0.53. This value compares well to those of 0.48 and, 0.56 calculated for quasi-2D Cu(ClO₄)₂(pyz)₂ and, CU(C₅H₅NO)₆(BF₄)₂, respectively, and is slightly larger than that found for CuF₂.2H₂O (0.42). As the T_{N}/J ratio increases, the more significant the 3D magnetic interactions become. Hence, these comparisons suggest the presence of a non-zero exchange interaction along the Cu—F—H—F—Cu pathway. We are currently studying the magnetochemical versatility of this system by substitution of BF₄⁻ for other counter-ions such as ClO₄⁻, PF₆⁻, and others. Additional synthetic and characterization studies are in progress.

The linear chain embodiment, CuF₂(H₂O)₂(pyz) has also been synthesized and characterized. The chain structure superficially resembles that of Cu(NO₃)₂(pyz) however, the essential difference between them is the extent of interchain interactions in the fluoride-complex. Strong F...H—O hydrogen bonds tether the chains together to yield a 2D square lattice that is linked in the third direction by pyrazine linkages. Magnetic susceptibility measurements combined with ESR and electronic structure calculations clearly show that the dₓ2_{-y}2 magnetic orbital is confined to the CuF₂O₂ plane thus placing the non-magnetic d_{z}2 orbital along the Cu-pyz-Cu direction. A broad maximum observed in χ(T) at 10 K indicates a modest magnetic interaction mediated by a Cu—F...H—O—Cu super-superexchange mechanism where a theoretical fit to a 2D quadratic model gave J/k_{B}=−5.58(1) K (Ĥ=−JΣSᵢ·Sⱼ). At lower temperatures, χ(T) shows a sharp peak at ˜2.6 K, that according to μSR studies is due to a transition to long-range magnetic ordering (LRO). The sharp peak is attributed to a spin-canting that is induced by the strengthening of the F...H—O hydrogen bond network as the temperature of the material is lowered. Isothermal M(H) measurements made at 2 K show a small hysteresis and a low-field phase transition near 500 Oe. Thus, while 1D linear chains with similar exchange energies are formed in both the CuF₂(H₂O)₂(pyz) and Cu(NO₃)₂(pyz) compounds, the presence of strong hydrogen bonds in the former causes the chains to alter their packing arrangement, thus leading to a novel ground state characterized by spin-canting and a dramatically increased critical temperature that is ˜25 times higher than that observed in Cu(NO₃)₂(pyz).

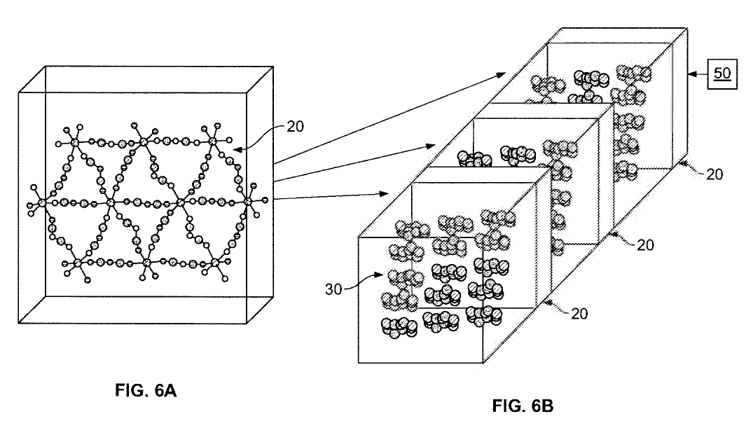

The [Cu(HF₂)(pyz)₂]BF₄ and CuF₂(H₂O)₂(pyz) compounds are two examples of the type of polymeric compound which can be reliably produced without defects and other disadvantages present in other organic or inorganic films. Such organic polymers provide strong electron-phonon coupling, large spin coherence, low temperature processing and substantial degrees of freedom in preparing synthetic polymers with the desired strong hydrogen bond coupling which will allow construction of organic polymer-based spintronic devices. As shown in FIGS. 6A and 6B, a polymeric magnetic layer 20 is disposed between the molecular sheets of a conducting layer 30. The strong hydrogen bonds will enable magnetic coupling to the conduction electrons, thereby enabling control of the spin state for a variety of commercial purposes. Therefore, for spintronic applications the magnetic polymer material can control the spin state of the electrons by a device 50 (see FIG. 6B) through the use of hydrogen bonds to effect a spin polarized current.

The foregoing description of embodiments of the present invention has been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments, and with various modifications, as are suited to the particular use contemplated.

What is claimed is:

1. A polymeric material having electron spin states which can be switched, comprising:
a coordination polymer material wherein a hydrogen bonded entity enables magnetic coupling between magnetic layers of the coordination polymer material, thereby enabling magnetic coupling of the unpaired electrons of metal centers of the polymer material and spin state can be switched.

2. The polymeric material as defined in claim 1 wherein the coordination polymer material comprises [M(A)ₙ(L)ₘ]X.

3. The polymeric material as defined in claim 2 wherein A comprises an anionic ligand possessing hydrogen bonding.

4. The polymeric material as defined in claim 3 wherein the anionic ligand consists essentially of HF₂⁻.

5. The polymeric material as defined in claim 2 wherein M consists essentially of at least one transition metal.

6. The polymeric material as defined in claim 5 wherein the transition metal consists of Cu.

7. The polymeric material as defined in claim 3 wherein L is selected from the group consisting of neutral multidentate ligands.

8. The polymeric material as defined in claim 2 wherein X consists of a charge balancing or structure directing entity.

9. The polymeric material as defined in claim 8 wherein the charge balancing entity is BF₄⁻.

10. The polymeric material as defined in claim 1 wherein the pyrazine based polymer material comprises [Cu(HF₂)(pyz)₂]BF₄.

11. The polymeric material as defined in claim 8 wherein the [Cu(HF₂)(pyz)₂]BF₄ is prepared by aqueous reaction of stoichiometric amounts of copper (II) tetrafluoroborate hydrate, ammonium bifluoride and pyz.

12. The polymer material as defined in claim 1 further including a spintronic device which can be applied to the pyrazine based polymer material to effect a switch in electron spin state.

13. The polymeric material as defined in claim 1, whereby electron spin coupling between the magnetic polymeric material and a conducting organic component can be effected through hydrogen bonding.

14. The polymeric material as defined in claim 1 wherein the hydrogen bonded entity is selected from the group consisting of F—H—F and O—H—F.
